(19) United States
(12) Patent Application Publication
(10) Pub. No.: US 2005/0114861 A1
(43) Pub. Date: May 26, 2005

(54) Parallel execution scheduling method apparatus and system

(76) Inventor: Brian Mitchell, North Ogden, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 10/988,437

(22) Filed: Nov. 12, 2004

Related U.S. Application Data
(60) Provisional application No. 60/519,123, filed on Nov. 12, 2003.

(51) Int. Cl. G06F 9/46

(52) U.S. Cl. 718/100

(57) ABSTRACT

A method, apparatus, and system for executing an application on a plurality of processing nodes within a heterogeneous computing environment associates a set of context-dependent procedures with each task to be performed and schedules a particular context-dependent procedure based on resource availability and needs. In certain embodiments, one are more tasks are organized into sequentially executed units of execution referred to as frames. The context-dependent procedures selected to perform each task within a frame may be selected to minimize the variance in resource utilization (such as processing time) within each frame. In one embodiment, a resource sufficiency test may be conducted for a selected procedure and the selected procedure may be scheduled for execution if the resource sufficiency test is affirmative.

### RELATED APPLICATIONS

The present application claims the benefit of U.S. Provisional Application No. 60/519,123, filed on Nov. 12, 2003.

### FIELD OF THE INVENTION

The present invention relates generally to data processing methods and systems. Specifically, the invention relates to methods and systems for simultaneously executing an application on multiple computers.

### BACKGROUND

Parallel processing remains an elusive goal in data processing systems. Although, many computational tasks are parallelizable, the complexity and inflexibility associated with parallel programming and execution techniques has restricted parallel execution to a few well-behaved problems such as weather forecasting and finite-element analysis. The complicated messaging and coordination mechanisms commonly used in parallel processing applications typically require that an application be rewritten for each execution environment. What is needed are methods and systems that enable parallel execution in a variety of execution environments.

### SUMMARY OF THE INVENTION

The present invention has been developed in response to the present state of the art, and in particular, in response to the problems and needs in the art that have not yet been fully solved by currently available parallel execution systems. Accordingly, the present invention has been developed to provide an improved method and system for executing applications in a heterogeneous computing environment that overcome many or all of the shortcomings in the art.

In one aspect of the present invention, a method for executing an application on a plurality of processing nodes includes associating a set of context-dependent procedures with a task, each procedure in the set of context-dependent procedures capable of executing the task in at least one computing context, invoking a resource sufficiency test for a selected procedure of the plurality of procedures associated with a task, and scheduling the selected procedure for execution if the resource sufficiency test is affirmative.

The context-dependent procedures selected for execution may be selected to balance resource utilization within a unit of execution known as a frame. In one embodiment, a resource consumption metric associated with each procedure indicates the estimated level of resource utilization required to execute the particular task. The resource consumption metric may be updated after actual execution of the procedure. For example, the resource consumption metric may be increased in response to slow execution, or decreased in response to fast execution.

In certain embodiments, invoking a resource sufficiency test includes inspecting a resource pool and removing resources from the resource pool if sufficient resources are available to enable execution. If sufficient resources are not available, the method may select another procedure from the set of context-dependent procedures to execute the desired task. In one embodiment, the initially selected procedure for each task is a procedure with the highest resource consumption metric and various combinations of procedures are tested until a combination is found that is capable of performing the required tasks with the available resources.

In some embodiments, tasks are assigned to various frames and the frames are used as loosely coupled units of execution within the computing environment. The tasks associated with a frame may be sequentially or concurrently executed subject to dependency constraints. In one embodiment, macroinstructions such as loop instructions, branch instructions, or end instructions may be associated with a frame in order to provide high-level flow control. In certain embodiments, a trigger may be associated with a frame that requires the occurrence of a specific event or condition before the tasks within the frame may be executed.

The present invention provides a flexible framework for developing and executing applications within heterogeneous computing environments. Resource utilization is initially estimated and balanced and subsequently refined based on actual usage. Utilization of a wide variety of resources may be factored into the procedure selection process such as processing nodes, communications bandwidth, volatile storage, and non-volatile storage.

In another aspect of the present invention an apparatus for performing the above-mentioned method includes an execution module comprising a plurality of context-dependent procedures capable of performing a task and a scheduler configured to execute a selected procedure of the plurality of context-dependent procedures. The scheduling module may also be configured to conduct a resource sufficiency test as a qualification for execution and schedule the selected procedure for execution if the resource sufficiency test is affirmative. In certain embodiments, the scheduler is configured to operate on frames that may have a trigger and/or macroinstruction associated therewith in order to provide high-level flow control within the deployed computing environment.

The various elements and aspects of the present invention facilitate parallel execution of applications on a plurality of computational nodes within a heterogeneous computing environment. Applications may be re-deployed within a different environment with little or no development. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one example of computing environment wherein the present invention may be deployed;

FIG. 2 is a block diagram depicting one embodiment of a parallel execution apparatus of the present invention; and

FIG. 3 is a flow chart diagram depicting one embodiment of a parallel execution method of the present invention.

### DETAILED DESCRIPTION OF THE INVENTION

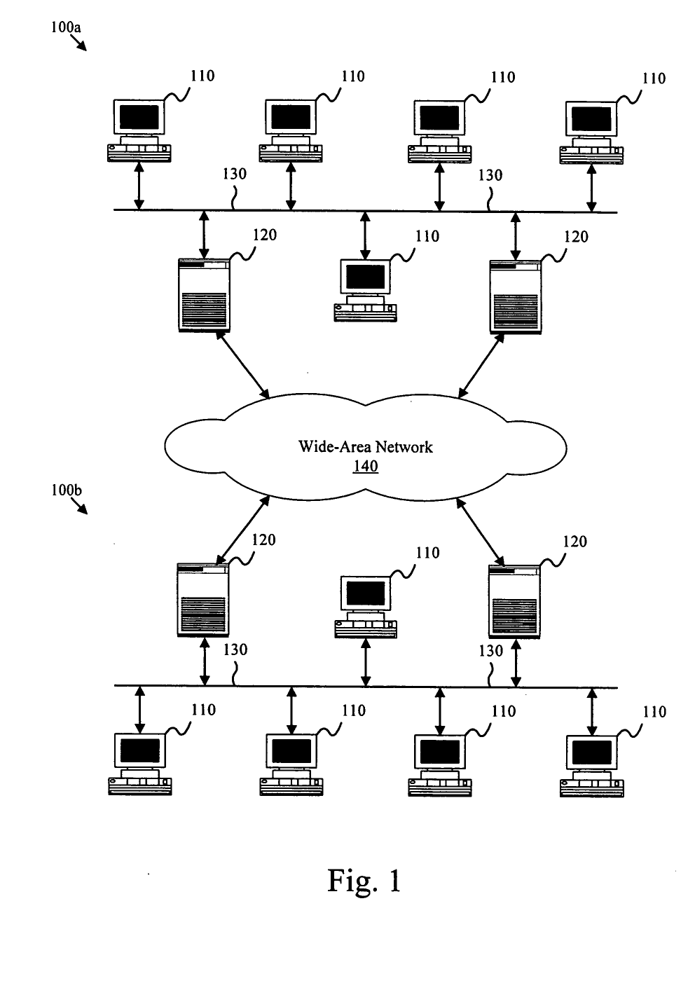

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 3, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments.

FIG. 1 is a schematic block diagram depicting one example of a computing environment 100 wherein the present invention may be deployed. The depicted computing environment 100 includes a first computing environment 100a and a second computing environment 100b containing various computing systems and devices such as workstations 110 and servers 120 interconnect by local area networks 130. A wide-area network 140, such as the internet, interconnects the computing environments 100a and 10b.

The computing environment 100 may be a heterogenous computing environment that includes computing devices and systems of widely varying storage capacity, processing performance, and communications bandwidth. Many of the computing devices and systems (i.e. computing nodes) may sit idle for considerable periods of time. The present invention provides means and methods to harness the resources of computing networks and environments such as the computing environment 100.

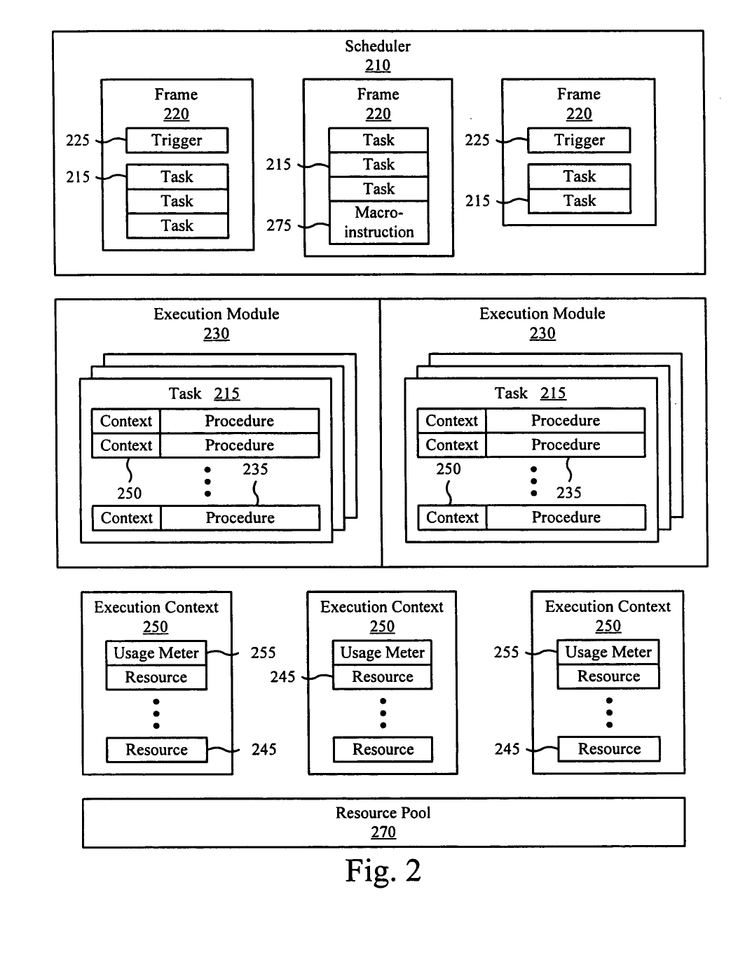

FIG. 2 is a block diagram depicting one embodiment of a parallel execution node 200 of the present invention. As depicted, the parallel execution node 200 includes a scheduler 210, one or more execution modules 230, one or more execution contexts 250, and a resource pool 270. The depicted parallel execution node 200 enables coordinated parallel execution in a robust manner and may be deployed on a variety of processing devices and systems such as those depicted in FIG. 1 in order to facilitate parallel execution of data processing tasks.

The depicted scheduler 210 enables execution of one or more course-grained functions or tasks 215 as a unit of execution known as a frame 220. The frames 220 are sequentially executed and may be loosely synchronized across a computing domain such as a grid. The tasks 215 within a frame may be sequentially or concurrently executed subject to any dependencies within the frame. Actual execution of the frame 220 may be deferred until (i.e. dependent on) occurrence of an event or condition referred to as a trigger 225.

The execution modules 230 contain application code in the form of invokable procedures 235 grouped into tasks 215. Each procedure 235 grouped within a particular task 215 may be capable of completing the task 215 within a particular execution context 250. The procedures 235 within an execution module 230 may also include procedures for partitioning and assembling datasets to enable parallel execution of specific tasks on multiple execution nodes 200. The execution modules 230 may also include a module descriptor (not shown). In one embodiment, the module descriptor describes the procedures and associated datasets within the module including parameters and dependencies.

In the depicted embodiment, each procedure 235 is associated with a computing context 240 that references a list of resources 245 needed to execute that particular procedure. In another embodiment, a resource allocation function (not shown) associated with the procedure 235 is invoked that determines whether sufficient resources are available in the resource pool 270 to execute the procedure. In certain embodiments, a usage meter or resource consumption metric 255 indicates the expected usage of resources for a procedure 235 and may be used to balance the usage of resources 245 by the various tasks within a frame. The resource consumption metric 255 may be updated after actual execution of the procedure. For example, the resource consumption metric 255 may be increased in response to slow execution, or decreased in response to fast execution.

The present invention uses the frames as units of execution within a computing environment such as a heterogeneous network of servers and workstations. In certain embodiments, branching and flow control macroinstructions 275 may be associated with the frames 220 in order to enable high level programmability. Providing the macroinstructions 275 simplifies development of procedures in that many conditional situations may be ignored by the context-dependent procedures. Providing the macroinstructions 275 also enables code re-use in that many applications may be created by using macroinstructions to invoke previously developed tasks and procedures.

The present invention provides a flexible framework for developing and executing applications within heterogeneous computing environments. Resource utilization is initially estimated and balanced and subsequently refined based on actual usage. Utilization of a wide variety of resources may be factored into the procedure selection process such as processing nodes, communications bandwidth, volatile storage, and non-volatile storage.

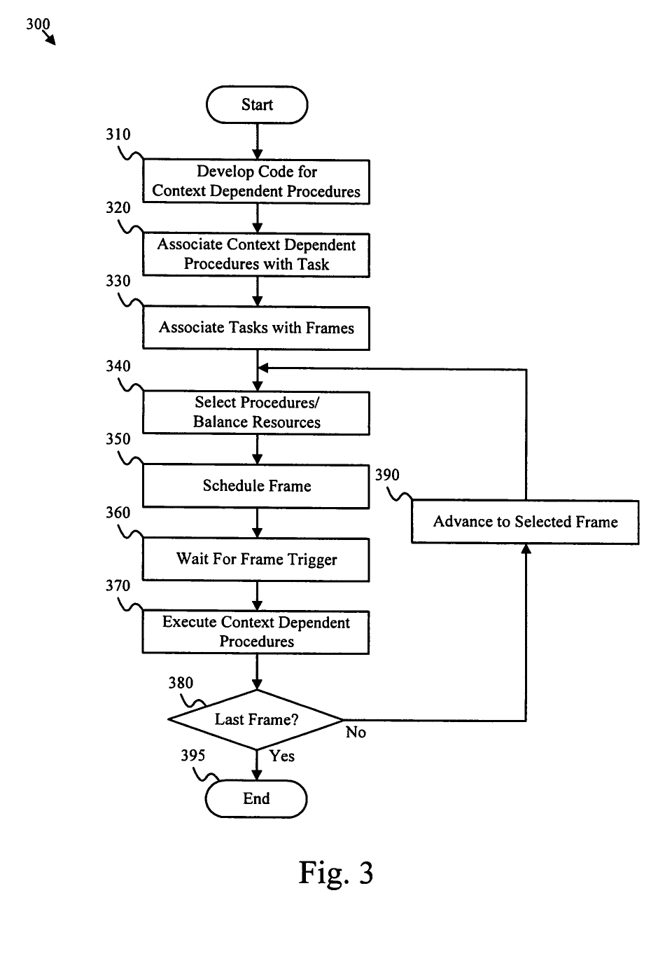

FIG. 3 is a flow chart diagram depicting one embodiment of a parallel execution method 300 of the present invention. The depicted parallel execution method 300 includes developing 310 one or more context-dependent procedures, associating 320 one or more context-dependent procedures with each task, associating 330 one or more tasks with each frame, selecting 340 a context-dependent procedure and associated resources for each task in a frame, scheduling 350 a frame for execution, waiting 360 for a frame trigger, executing 370 a context-dependent procedure for each task in a frame, testing 380 for a last frame, and advancing 390 to a next frame. The depicted parallel execution method 300 enables balanced processing in heterogeneous computing environments. One of skill in the art will appreciate that the described processing steps may be accomplished in a manner appropriate for the platform on which it is deployed and need not be executed in the depicted order.

Developing 310 one or more context-dependent procedures may include developing several different procedures each of which are capable of completing a task in a different computing context or environment. For example, one procedure may enable completion of a task on a single node, while another procedure may partition a task and enable completion on multiple nodes.

Associating 320 one or more context-dependent procedures with each task provides the scheduler 210, or the like, with one or more execution options for a particular task. Subsequently, associating 330 one or more tasks with each frame provides the scheduler 210 with convenient units of execution. In one embodiment, the tasks to be associated together and executed within a frame are selected by a programmer or system administrator based on their knowledge of system performance. In another embodiment, an optimizer groups tasks into frames.

Selecting 340 a context-dependent procedure for each task in a frame may include assessing whether sufficient resourses are available to execute the context-dependent procedure. In certain embodiments, a usage meter or resource consumption metric indicates the expected usage of resources for a context-dependent procedure. In one embodiment, selecting 340 includes finding a combination of context-dependent procedures that provides the least variance in (expected) resource consumption including processing time. In another embodiment, a computing context identifier is specified by the application and the selected procedure is a procedure that is registered to execute the identified computing context.

In certain embodiments, selecting 340 a context-dependent procedure includes inspecting a resource pool and removing resources from the resource pool if sufficient resources are available to enable execution. If sufficient resources are not available, the another procedure from the set of context-dependent procedures may be selected to execute the desired task. In one embodiment, the initially selected procedure for each task is a procedure with the highest resource consumption metric and various combinations of procedures are tested until a combination is found that is capable of performing the required tasks with the available resources.

Scheduling 350 a frame for execution may include placing the frame in a pending execution queue (not shown). Waiting 360 for a frame trigger may include waiting for a specific event or condition. Subsequently, executing 370 may include invoking a context-dependent procedure for each task in a frame or placing a handle to each context-dependent procedure in an execution queue (not shown) or the like.

Testing 380 for a last frame tests whether additional frames need to be processed. In one embodiment, testing 380 for a last frame includes ascertaining whether the current frame includes a macroinstruction such as a loop instruction, a branch instruction, or an end instruction. If the last frame has been processed the method ends 395, otherwise, the method continues by advancing 390 to a selected frame such as a frame indicated by a macroinstruction.

The present invention provides means and methods to schedule and execute applications (in parallel) on a plurality of computational nodes within a heterogeneous computing environment. The present invention eases the development and deployment of parallel execution applications. Applications may be redeployed within a different environment with little or no development.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for executing an application on a plurality of processing nodes, the apparatus comprising:
associating a plurality of procedures with a task, each procedure of the plurality of procedures capable of executing the task in at least one computing context;
invoking a resource sufficiency test for a selected procedure of the plurality of procedures associated with a task; and
scheduling the selected procedure for execution if the resource sufficiency test is affirmative.

2. The method of claim 1, wherein the selected procedure is selected to balance resource utilization.

3. The method of claim 1, wherein invoking a resource sufficiency test comprises inspecting a resource pool.

4. The method of claim 3, further comprising removing resources from the resource pool.

5. The method of claim 3, further comprising selecting another procedure of the plurality of procedures in response to a depleted resource pool.

6. The method of claim 1, further comprising assigning at least one task to a frame.

7. The method of claim 6, wherein tasks associated with the frame are sequentially executed.

8. The method of claim 6, wherein tasks associated with the frame are concurrently executed.

9. The method of claim 6, further comprising associating a macroinstruction with a frame.

10. The method of claim 6, further comprising looping to a previous frame.

11. The method of claim 6, further comprising branching to another frame.

12. The method of claim 6, further comprising balancing resource utililization within a frame.

13. The method of claim 1, further comprising assigning a resource consumption metric to each procedure of the plurality of procedures associated with a task.

14. The method of claim 13, further comprising increasing the resource consumption metric in response to slow execution.

15. The method of claim 13, further comprising reducing the resource consumption metric in response to fast execution.

16. The method of claim 1, wherein the selected procedure corresponds to a specified computing context.

17. The method of claim 16, wherein executing the selected procedure occurs in response to a trigger.

18. The method of claim 17, wherein the trigger comprises a condition.

19. The method of claim 17, wherein the trigger comprises an event.

20. The method of claim 1, wherein a context of the plurality of computing contexts is application definable.

21. The method of claim 1, wherein a context of the plurality of computing contexts corresponds to specific resource requirements.

22. The method of claim 22, wherein the resource requirements are selected from the group consisting of processing nodes, communications bandwidth, volatile storage, and non-volatile storage.

23. An apparatus for executing an application on a plurality of processing nodes, the apparatus comprising:
an execution module comprising a plurality of procedures associated with a task, each procedure of the plurality of procedures capable of executing the task in at least one computing context; and
a scheduler configured to execute a selected procedure of the plurality of procedures, the selected procedure corresponding to a specified computing context.

24. An apparatus for executing an application on a plurality of processing nodes, the apparatus comprising:
a module of executable code comprising a plurality of procedures associated with a task, each procedure of the plurality of procedures capable of executing the task in at least one computing context; and
a scheduler configured to conduct a resource sufficiency test for a selected procedure of the plurality of procedures and schedule the selected procedure for execution if the resource sufficiency test is affirmative.

25. The apparatus of claim 24, wherein the selected procedure is selected to balance resource utilization.

26. The apparatus of claim 24, wherein conducting a resource sufficiency test comprises inspecting a resource pool.

27. The apparatus of claim 26, wherein the scheduler is further configured to remove resources from the resource pool.

28. The apparatus of claim 24, wherein the scheduler is further configured to select another procedure of the plurality of procedures in response to a depleted resource pool.

29. The apparatus of claim 24, wherein the scheduler is further configured to assign at least one task to a frame.

30. The apparatus of claim 29, wherein the scheduler is further configured to schedule sequential execution of tasks associated with the frame.

31. The apparatus of claim 29, wherein the scheduler is further configured to schedule concurrent execution of tasks associated with the frame.

32. The apparatus of claim 29, wherein tasks associated with the frame are concurrently executed.

33. The apparatus of claim 29, wherein the scheduler is further configured to initiate execution of a macroinstruction associated with a frame.

34. The apparatus of claim 33, wherein the scheduler is further configured to initiate looping to a previous frame.

35. The apparatus of claim 33, wherein the scheduler is further configured to initiate branching to another frame.

36. The apparatus of claim 29, wherein the scheduler is further configured to balance resource utililization within a frame.

37. The apparatus of claim 24, wherein the scheduler is further configured to increase a resource consumption metric in response to slow execution.

38. The apparatus of claim 24, wherein the scheduler is further configured to decrease a resource consumption metric in response to fast execution.

39. The apparatus of claim 24, wherein the scheduler is further configured to initiate execution of the selected procedure in response to a trigger.

40. An apparatus for executing an application on a plurality of processing nodes, the apparatus comprising:
means for associating a plurality of procedures with a task, each procedure of the plurality of procedures capable of executing the task in at least one computing context;
means for invoking a resource sufficiency test for a selected procedure of the plurality of procedures associated with a task; and
means for scheduling the selected procedure for execution if the resource sufficiency test is affirmative.

41. A system for executing an application on a plurality of processing nodes, the system comprising:
a plurality of processing nodes, each processing node thereof comprising an execution module comprising a plurality of procedures associated with a task, each procedure of the plurality of procedures capable of executing the task in at least one computing context; and
a scheduler configured to conduct a resource sufficiency test for a selected procedure of the plurality of procedures and schedule the selected procedure for execution if the resource sufficiency test is affirmative.

42. A computer readable medium comprising computer readable program code configured to carry out a method for executing an application on a plurality of processing nodes, the method comprising:
associating a plurality of procedures with a task, each procedure of the plurality of procedures capable of executing the task in at least one computing context;
invoking a resource sufficiency test for a selected procedure of the plurality of procedures associated with a task; and
scheduling the selected procedure for execution if the resource sufficiency test is affirmative.
